(19) United States
(12) Patent Application Publication
(10) Pub. No.: US 2024/0348112 A1
(43) Pub. Date: Oct. 17, 2024

(54) ELECTRIC MOTOR, AND BLOWER

(71) Applicant: Mitsubishi Electric Corporation, Tokyo (JP)

(72) Inventors: Kazuchika TSUCHIDA, Tokyo (JP); Ryogo TAKAHASHI, Tokyo (JP); Daisuke MORISHITA, Tokyo (JP); Takaya SHIMOKAWA, Tokyo (JP); Takanori WATANABE, Tokyo (JP)

(21) Appl. No.: 18/683,309

(22) PCT Filed: Sep. 6, 2021
(86) PCT No.: PCT/JP2021/032612

§ 371 Date: Feb. 13, 2024

(51) Int. Cl. H02K 1/18; F04D 25/06; F04D 29/26; H02K 1/14; H02K 7/08; H02K 21/16

(52) U.S. Cl. CPC H02K 1/185; F04D 25/06; F04D 29/26; H02K 1/146; H02K 7/083; H02K 21/16

(57) ABSTRACT

A stator includes a stator core including a plurality of teeth, a plurality of magnetic flux capture members, and a resin to fix the magnetic flux capture members to end surfaces in an axial direction of the teeth respectively. The magnetic flux capture members, which are adjacent in a circumferential direction of the stator core, of the plurality of magnetic flux capture members are disposed in the circumferential direction with a first gap in between, and the first gap is filled with the resin.

### CROSS REFERENCE TO RELATED APPLICATION

This application is a U.S. national stage application of PCT/JP2021/032612 filed on Sep. 6, 2021, the contents of which are incorporated herein by reference.

### TECHNICAL FIELD

The present disclosure relates to a stator, an electric motor, and a blower.

### BACKGROUND

In a stator of an electric motor, there is a known configuration in which an extending portion consisting of a plurality of plates is disposed on the axial end surface of the tooth of the stator core. See, for example, Patent Reference 1.

### PATENT REFERENCE

Patent Reference 1: Japanese Patent Application Publication No. 2014-124007 (See, for example, FIG. 1)

However, the extending portion may vibrate during rotation of the electric motor. For example, the extending portion may vibrate with the magnetic force of the rotor. Also, the extending portion vibrates when magnetic attractive and repulsive forces are generated between the rotor and the stator due to the application of current to the stator windings. For that reason, it is necessary to reduce the noise in the stator caused by the vibration.

### SUMMARY

It is an object of the present disclosure to reduce noise in a stator.

An electric motor according to an aspect of the present disclosure includes a stator, and a rotor body disposed inside the stator; a rotation shaft attached to the rotor body; a first bearing that supports a load side of the rotation shaft; and a second bearing that supports an anti-load side of the rotation shaft, wherein the stator includes: a stator core including a plurality of teeth; a plurality of magnetic flux capture members; and a resin to fix the magnetic flux capture members to end surfaces, in an axial direction of the stator core, of the teeth respectively, wherein the magnetic flux capture members, which are adjacent in a circumferential direction of the stator core, of the plurality of magnetic flux capture members are disposed in the circumferential direction with a first gap in between, the first gap is filled with the resin, and a distance between the first bearing and the second bearing in the axial direction is greater than or equal to a length of the rotor body in the axial direction.

According to the present disclosure, it is possible to reduce noise in the stator.

### BRIEF DESCRIPTION OF THE DRAWINGS

FIG. 1 is a partial cross-sectional view schematically showing a configuration of a blower according to a first embodiment.

FIG. 2 is a perspective view of a portion of the stator of the electric motor shown in FIG. 1.

FIG. 3 is a cross-sectional view of a portion of the stator, shown in FIGS. 1 and 2, which is cut in conformity with the curved surface extending in the circumferential direction about the axis line of the shaft.

FIG. 4 is an enlarged cross-sectional view showing a portion of the stator of the electric motor shown in FIG. 1.

FIG. 5A to FIG. 5C are cross-sectional views showing other examples of the configuration of the stator according to the first embodiment.

FIG. 6A and FIG. 6B are cross-sectional views showing yet additional examples of the configuration of the stator according to the first embodiment.

FIG. 7A is a cross-sectional view of another example of the configuration of the resin shown in FIG. 4. FIGS. 7B to 7E are cross-sectional views showing yet additional examples of the configuration of the resin shown in FIG. 4.

FIG. 8 is a cross-sectional view showing a schematic configuration of an electric motor according to a first modification of the first embodiment.

FIG. 9 is a cross-sectional view schematically showing a part of the configuration of an electric motor according to the second embodiment.

FIG. 10A is a partial cross-sectional view showing the configuration of a rotor of an electric motor according to third embodiment. FIG. 10B is a partial cross-sectional view showing the configuration of the rotor of an electric motor according to the comparative example.

FIG. 11 is a perspective view showing the configuration of the stator of the electric motor according to fourth embodiment.

FIG. 12 is a perspective view showing the stator core and an insulator shown in FIG. 11.

FIG. 13A is a plan view showing the magnetic flux capture member shown in FIG. 11. FIG. 13B to FIG. 13D are plan views showing other examples of the configuration of the magnetic flux capture member according to the fourth embodiment.

FIG. 14A is a plan view showing a configuration of a magnetic flux capture member of a stator according to first modification of the fourth embodiment. FIG. 14B is a plan view showing other example of the configuration of the magnetic flux capture member of the first modification of the fourth embodiment.

FIG. 15 is a plan view showing a configuration of a magnetic flux capture member of a stator according to the second modification of the fourth embodiment.

### DETAILED DESCRIPTION

A stator, an electric motor, and a blower according to the embodiments of the present disclosure will now be described below with reference to the attached drawings. The following embodiments are merely examples, and can be modified in various ways within the scope of the present disclosure.

In order to make it easy to understand the relationships between the drawings, an xyz orthogonal coordinate system is shown in each drawing. The z-axis is the coordinate axis parallel to the axis of a rotor of the electric motor. The x-axis is the coordinate axis orthogonal to the z-axis. The y-axis is the coordinate axis orthogonal to both the x-axis and the z-axis.

### Configuration of Blower 150

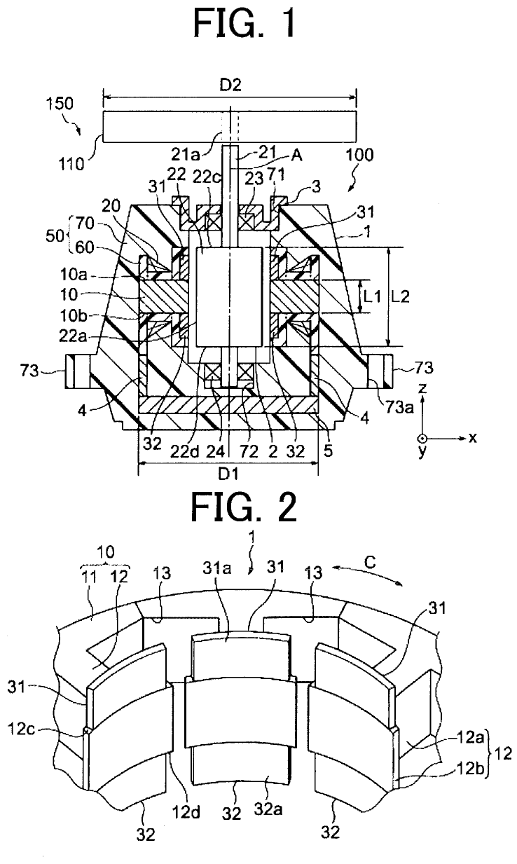

FIG. 1 is a partial cross-sectional view schematically showing a configuration of a blower 150 according to a first embodiment. As shown in FIG. 1, the blower 150 includes an electric motor 100, an impeller (also referred to as a “blade” or a “fan”) 110. The impeller 110 is driven by the electric motor 100, thereby generating airflow.

### Structure of Electric Motor 100

The electric motor 100 includes a stator 1 and a rotor 2. It should be noted that the configuration of the stator 1 is described later.

The rotor 2 includes a shaft 21 as a rotation shaft, a permanent magnet 22 as a rotor body, a first bearing 23, and a second bearing 24. The rotor 2 can rotate around the axis A of the shaft 21. The shaft 21 protrudes from the stator 1 toward the +z axis side. It should be noted that, in a description hereafter, the direction along the circumference of a circle centered on the axis A of the shaft 21 is referred to as a “circumferential direction C.” Also, a direction along the z-axis is also referred to as an “axial direction” and a direction perpendicular to the axial direction is also referred to as a “radial direction.” Also, a protruding side of the shaft 21 (i.e., the +z-axis side) is referred to as a “load side,” and the opposite side (i.e., the −z-axis side) of the shaft 21 from the load side is referred to as an “anti-load side.”

The permanent magnet 22 is disposed inward from the stator 1. The permanent magnet 22 is attached to the shaft 21. In the example shown in FIG. 1, the permanent magnet 22 is a cylindrical magnet that extends in the z-axis direction. N poles and S poles are alternately formed on an outer peripheral surface 22a of the permanent magnet 22. It should be noted that the rotor body of the rotor 2 may be composed of a rotor core fixed to the shaft 21 and a permanent magnet attached to the rotor core.

The first bearing 23 is a bearing that supports the load side of the shaft 21. The first bearing 23 is held by a metal bracket 3. The second bearing 24 is a bearing that supports the anti-load side of the shaft 21. The second bearing 24 is held by a bearing holding portion 72, described below, included in the stator 1. The first bearing 23 and the second bearing 24 are rolling bearings.

### Configuration of Stator 1

Next, the configuration of the stator 1 will now be described. The stator 1 includes a stator core 10, a winding 20, magnetic flux capture members 31 and 32, and a resin 50.

FIG. 2 is a perspective view of a portion of the stator 1 of the electric motor 100 shown in FIG. 1. As shown in FIG. 2, the stator core 10 includes a yoke 11 extending in the circumferential direction C and a plurality of teeth 12. The teeth 12 are disposed at predetermined intervals in the circumferential direction C. A slot 13, which is a space in which the winding 20 (see, FIG. 1) is accommodated, is provided between two adjacent teeth 12 of the plurality of teeth 12 in the circumferential direction C.

The teeth 12 face the rotor 2 (see FIG. 1) in the radial direction. Each of the teeth 12 includes a tooth body 12a and a tooth end portion 12b. The tooth body 12a extends inward from the yoke 11 in the radial direction. The tooth end portion 12b is disposed inward from the tooth body 12a in the radial direction and is wider than the tooth body 12a in the circumferential direction C.

As shown in FIG. 1, the stator core 10 includes a first end surface 10a, which is one end surface in the axial direction (specifically, the end surface facing in the +z-axis direction), and a second end surface 10b, which is the other end surface (specifically, the end surface facing in the −z-axis direction). Also, the permanent magnet 22 described above includes a third end surface 22c, which is one end surface in the axial direction (specifically, the end surface facing in the +z-axis direction), and a fourth end surface 22d, which is the other end surface (specifically, the end surface facing in the −z-axis direction).

A length L1 is shorter than a length L2, where L1 is a first length that is the length of the stator core 10 in the z-axis direction (hereafter also referred to as an “axial length”) and L2 is a second length that is the length of the permanent magnet 22 in the z-axis direction. That is, the length L1 and the length L2 satisfy the following Expression (1).

$$L 1 < L 2 \qquad ( 1 )$$

The stator core 10 includes a plurality of electrical steel sheets (not shown) laminated in the z-axis direction. When the length L1 is shorter than the length L2, the number of electrical steel sheets included in the stator core 10 is reduced, thereby reducing the cost of the stator core 10. Thus, the cost of the electric motor 100 can be reduced.

In the example shown in FIG. 1, the first end surface 10a and the second end surface 10b of the stator core 10 are disposed between the third end surface 22c and the fourth end surface 22d of the permanent magnet 22. It should be noted that at least one of the first end surface 10a or the second end surface 10b has only to be disposed between the third end surface 22c and the fourth end surface 22d of the permanent magnet 22. For example, the second end surface 10b of the stator core 10 may be located outward from the fourth end surface 22d of the permanent magnet 22 in the axial direction.

As described above, in the electric motor 100, the length L1 in the z-axis direction of the stator core 10 is shorter than the length L2 in the z-axis direction of the permanent magnet 22. Generally, when the length in the z-axis direction of the stator core is shorter than the length in the z-axis direction of the rotor body (in the first embodiment, corresponding to the permanent magnet 22), magnetic flux generated at the end portion, which does not face the stator core in the radial direction (hereinafter referred to as an “overhang portion”), in the z-axis direction of the rotor body does not flow easily into the stator core and the winding. Thus, if the amount of the magnetic flux flowing from the rotor body into the stator core and the winding is reduced, the output and efficiency of the electric motor may be reduced.

In the first embodiment, the stator 1 includes the magnetic flux capture members 31 and 32 made of magnetic material that capture the magnetic flux of the permanent magnet 22. Accordingly, the magnetic flux generated at the overhang portion of the permanent magnet 22 can easily flow into the stator core 10 and the winding 20 through the magnetic flux capture members 31 and 32. Therefore, according to the first embodiment, the cost of the electric motor 100 can be reduced and the output and efficiency of the electric motor 100 can be prevented from decreasing. For that reason, even if an inexpensive magnet having low magnetic force (e.g., ferrite magnet) is used as the permanent magnet 22 in the rotor 2 of the electric motor 100, there is no need to increase the axial length of the stator core 10 and the height of the winding 20 in the z-axis direction because the magnetic flux capture members 31 and 32 capture the magnetic flux of the magnet. Therefore, even when an inexpensive magnet having low magnetic force as the permanent magnet 22 is used in the electric motor 100, the cost of the electric motor 100 can be reduced and the output and efficiency of the electric motor 100 can be prevented from decreasing.

Next, the details of the configuration of the magnetic flux capture members 31 and 32 will be described. The magnetic flux capture members 31 and 32 are, for example, metal pieces formed of metal. Specifically, the magnetic flux capture members 31 and 32 are iron pieces formed of iron.

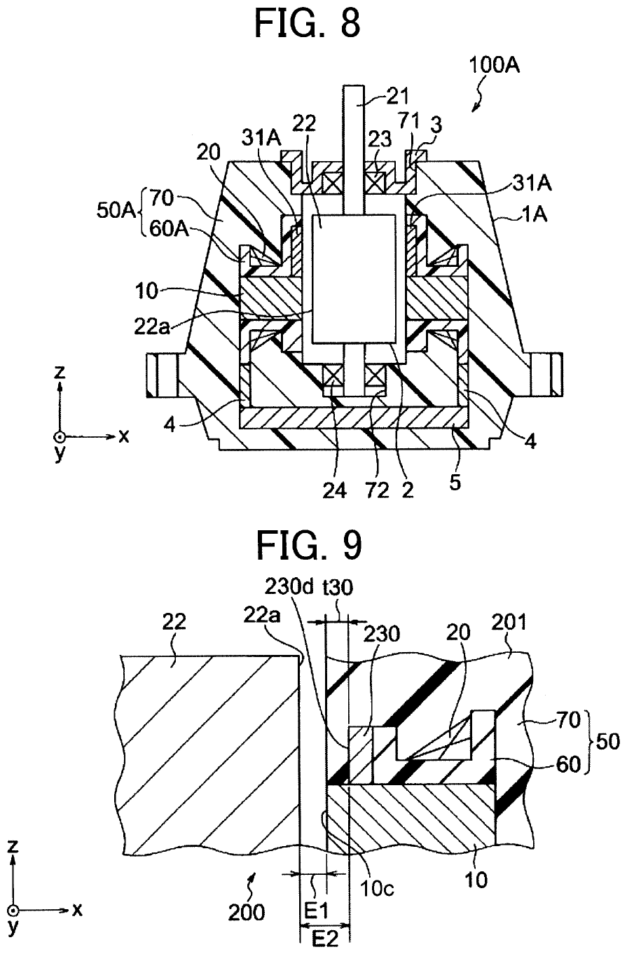

The plurality of the magnetic flux capture members 31 and 32 are disposed at intervals from each other in the circumferential direction C. Specifically, the magnetic flux capture member 31 is disposed on the end surface 12c, which faces the +z-axis direction, of the tooth 12, and the magnetic flux capture member 32 is disposed on the end surface 12d, which faces the −z-axis direction, of the tooth 12. It should be noted that, as shown in FIG. 8 referenced later, the stator 1 can be achieved without the magnetic flux capture member 32.

As shown in FIG. 2, the magnetic flux capture members 31 and 32 are disposed in the tooth end portion 12b of the tooth 12. Accordingly, compared to a configuration in which the magnetic flux capture members 31 and 32 are disposed in the tooth body 12a, the magnetic flux capture members 31 and 32 are disposed closer to the permanent magnet 22 (see, FIG. 1), and thus the magnetic flux of the permanent magnet 22 is easily captured by the magnetic flux capture members 31 and 32.

Also, the respective shapes of the magnetic flux capture members 31 and 32 as seen in the z-axis direction are, for example, curved shapes (e.g., arc shapes) including concave surfaces 31a and 32a respectively facing inward in the radial direction. It should be noted that the respective shapes of the magnetic flux capture members 31 and 32 as seen in the z-axis direction may be rectangular.

The magnetic flux capture members 31 and 32 may vibrate with the magnetic force of the permanent magnet 22. For example, the magnetic flux capture members 31 and 32 may vibrate in the circumferential direction C with the magnetic force of the permanent magnet 22 during the rotation of the electric motor 100. Also, the electric motor 100 rotates when a current is applied to the winding 20 (see, FIG. 1) and magnetic attractive and repulsive forces are generated between the rotor 2 and the stator 1. The magnetic attractive and repulsive forces generated by energizing the winding 20 also serve as a source of vibration for the magnetic flux capture members 31 and 32, which are the components of the electric motor 100. Therefore, it is necessary to suppress the vibration of the magnetic flux capture members 31 and 32 due to the magnetic force of the permanent magnet 22 or the magnetic force generated when energizing the winding 20.

Also, in the example shown in FIG. 1, the shaft 21 protrudes from the stator 1 in the +z-axis direction to transmit the rotation drive force of the electric motor 100. In this case, there is concern about the generation of noise due to twisting of the protruding portion, which is the portion including an end portion 21a that is a power transmission portion, of the shaft 21 that protrudes from the permanent magnet 22 to the load side (i.e., the +z-axis side).

Specifically, in the first embodiment, the outer diameter D2 of the vane of the impeller 110 attached to the end portion 21a of the shaft 21 is larger than the outer diameter D1 of the stator core 10. In this case, the protruding portion of the shaft 21 tends to twist because of the large inertia of the impeller 110. Also, there is concern about the generation of vibration due to the flexing of the shaft 21 by each of the self-weight of the shaft 21 and the impeller 110. When the vibration component caused by the twisting and bending of the shaft 21 resonates with the vibration component caused by the magnetic force of the permanent magnet 22 described above, etc., a loud noise is generated in the electric motor 100.

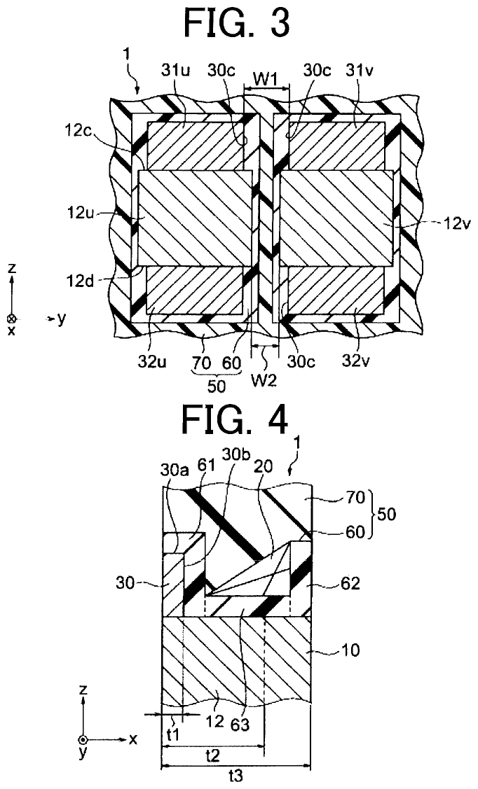

Hereafter, the configuration for suppressing vibration of the magnetic flux capture members 31 and 32 will be described. FIG. 3 is a cross-sectional view of a portion of the stator 1, shown in FIG. 1, which is cut in conformity with the curved surface extending in the circumferential direction C. In FIG. 3, the plurality of magnetic flux capture members 31 are denoted as 31u and 31v, the plurality of magnetic flux capture members 32 as 32u and 32v, and the plurality of teeth 12 as 12u and 12v. Also, in FIG. 3, the gap between adjacent magnetic flux capture members 31u and 31v in the circumferential direction C and the gap between adjacent magnetic flux capture members 32u and 32v in the circumferential direction C are collectively denoted as a “first gap W1” and the gap between adjacent teeth 12u and 12v in the circumferential direction C is denoted as a “second gap W2.”

The resin 50 fixes the magnetic flux capture members 31u, 31v, 32u, and 32v to the teeth 12u and 12v, respectively. Accordingly, vibration of the magnetic flux capture members 31u, 31v, 32u, and 32v in the circumferential direction C caused by magnetic force such as the magnetic force of the permanent magnet 22 can be suppressed. In the first embodiment, the resin 50 surrounds the plurality of magnetic flux capture members 30 so as to fix the plurality of magnetic flux capture members 30 to the end surfaces 12c and 12d in the z-axis direction of the plurality of teeth 12.

The first gap W1 is filled with the resin 50. Accordingly, the magnetic flux capture members 31u, 31v, 32u, and 32v are hard to move in the circumferential direction C. Therefore, even when the magnetic forces described above (e.g., the magnetic force of the permanent magnet 22 and the magnetic force generated when the winding 20 is energized) act on the magnetic flux capture members 31u, 31v, 32u, and 32v, the vibration of the magnetic flux capture members 31u, 31v, 32u, and 32v can be suppressed. Therefore, noise in the stator 1, in other words, noise in the electric motor 100 can be reduced.

In the example shown in FIG. 3, the first gap W1 is filled with the resin 50, and the second gap W2 between adjacent teeth 12u and 12v in the circumferential direction Cis also filled with the resin 50. Accordingly, the vibration of the teeth 12u and 12v during the rotation of the electric motor 100 can be suppressed.

Also, in the example shown in FIG. 3, the first gap W1 is larger than the second gap W2. That is, the first gap W1 and the second gap W2 satisfy the following Expression (2).

$$W 1 > W 2 \qquad ( 2 )$$

The first gap W1 and the second gap W2 satisfy the Expression (2), thereby increasing the amount of the resin 50 with which the first gap W1 is filled. Accordingly, the magnetic flux capture members 31u, 31v, 32u, and 32v can be more firmly fixed to the end surfaces 12c and 12d of the teeth 12u and 12v in the z-axis direction. Hence, the vibrations of the magnetic flux capture members 31u, 31v, 32u, and 32v due to the magnetic force generated between the rotor 2 and the stator 1 can be further suppressed. Therefore, the noise in the stator 1 can be further reduced. Also, since the magnetic flux capture members 31u, 31v, 32u, and 32v are more prone to vibration than the teeth 12u and 12v, it is preferable to make the first gap W1 larger than the second gap W2, as shown in the Expression (2). It should be noted that the first gap W1 may be the same as the second gap W2. In other words, the first gap W1 may be greater than or equal to the second gap W2.

Also, as shown in FIG. 2 and FIG. 3, each width of the magnetic flux capture members 31 and 32 in the circumferential direction C is narrower than the width of the tooth end portion 12b in the circumferential direction C. Accordingly, each of the surface area (in other words, volume) of the magnetic flux capture members 31 and 32 becomes smaller, and thus the amount of magnetic flux passing through the magnetic flux capture members 31 and 32 is reduced. Therefore, the magnetic force in the magnetic flux capture members 31 and 32 is reduced, and thus the vibration of the magnetic flux capture members 31 and 32 can be further suppressed. It should be noted that, in the explanation hereafter, when there is no need to distinguish between the magnetic flux capture members 31 and 32, they are collectively referred to as a “magnetic flux capture member 30.”

FIG. 4 is an enlarged cross-sectional view showing a portion of the stator 1 of the electric motor 100 shown in FIG. 1. As shown in FIG. 4, a first thickness t1 is thinner than a second thickness t2, where the first thickness t1 is the thickness of the magnetic flux capture member 30 in the radial direction and the second thickness t2 is the thickness of the tooth 12 in the radial direction. That is, the first thickness t1 and the second thickness t2 satisfy the following Expression (3).

$$t 1 < t 2 \qquad ( 3 )$$

Accordingly, the volume of the magnetic flux capture member 30 becomes smaller, and thus the amount of magnetic flux passing through the magnetic flux capture member 30 is reduced. Hence, the magnetic force acting on the magnetic flux capture member 30 is reduced, and thus the vibration of the magnetic flux capture member 30 can be suppressed. Consequently, the generation of noise in the stator 1 can be further reduced.

Next, the structure of the resin 50 will be described. As shown in FIGS. 1, 3 and 4, the resin 50 includes an insulator 60 and a mold resin 70.

The insulator 60 is an insulating member that insulates the winding 20 from the stator core 10. The insulator 60 is formed of thermoplastic resin such as Poly Phenylene Sulfide (PPS) or Poly Butylene Terephthalate (PBT), for example.

As shown in FIG. 1 and FIG. 4, the insulator 60 includes a first insulating portion 61, a second insulating portion 62, and an extending portion 63 as a third insulating portion.

The first insulating portion 61 is the portion, which is provided inward from the winding 20 in the radial direction and covers the tooth 12, of the insulator 60. The first insulating portion 61 covers an end surface 30a that faces in the +z-axis direction and a surface 30b that faces outward in the radial direction, of the magnetic flux capture member 30. Accordingly, the magnetic flux capture member 30 can be more firmly fixed to the stator core 10. Thus, the vibration of the magnetic flux capture member 30 due to magnetic force is suppressed and the noise in the stator 1 can be further reduced.

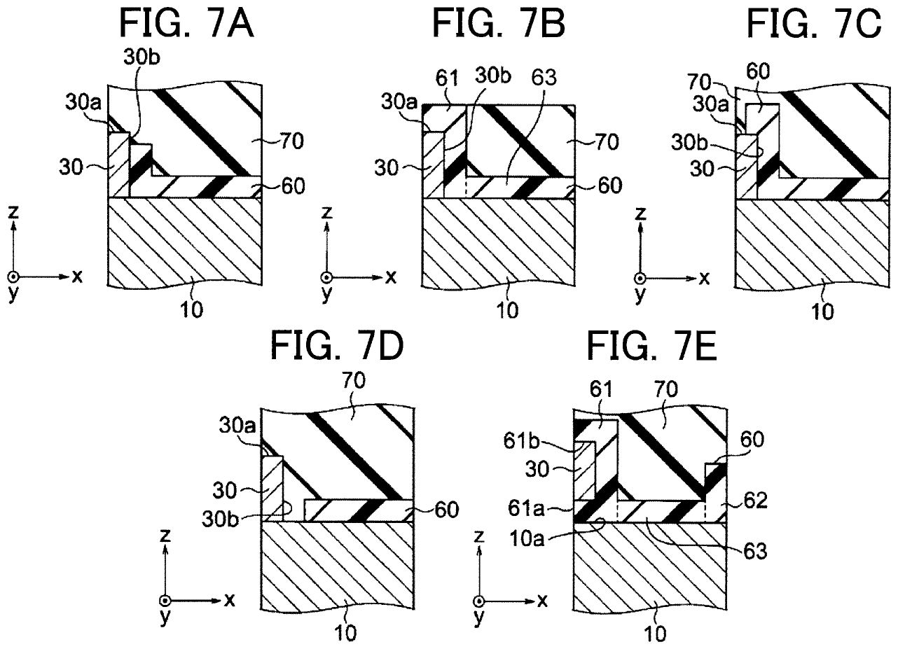

The second insulating portion 62 is the portion, which is provided outward from the winding 20 in the radial direction and covers the yoke 11, of the insulator 60. The extending portion 63 is the portion, which connects the first insulating portion 61 and the second insulating portion 62, of the insulator 60. The extending portion 63 extends outward, in the radial direction, from the end on the −z-axis-side of the first insulating portion 61. It should be noted that, as shown in FIG. 7B referenced later, the insulator 60 can be achieved without the second insulating portion 62.

In FIG. 4, a third thickness t3 is thicker than the first thickness t1, where t3 is the thickness in the radial direction of the insulator 60. That is, the first thickness t1 and the third thickness t3 satisfy the following equation (4).

$$t 3 > t 1 \qquad ( 4 )$$

Generally, the sound transmission rate varies with the thickness of the material through which the sound is transmitted. For that reason, when the thickness in the radial direction (i.e., third thickness t3) of the resin 50 (e.g., insulator 60) with which the first gap W1 is filled shown in FIG. 3 described above is thicker than the thickness in the radial direction (i.e., first thickness t1) of the magnetic flux capture member 30, the vibration of the magnetic flux capture member 30 can be further suppressed.

The mold resin 70 is formed, for example, of thermosetting resin. The mold resin 70 is formed, for example, by injection molding. Also, the mold resin 70 is united with the stator core 10, the winding 20, the magnetic flux capture member 30, and the insulator 60 with integral molding.

The mold resin 70 covers the winding 20. In other words, the mold resin 70 fixes the winding 20 to the stator core 10. Accordingly, the vibration of the winding 20 due to magnetic or Lorentz forces when energized is suppressed, thereby further reducing the noise in the stator 1.

As shown in FIG. 1, the mold resin 70 includes an opening 71, a bearing holding portion 72, and a fixing portion 73. The metal bracket 3 supporting the first bearing 23 on the load side is fixed to the opening 71. The metal bracket 3 is fixed to the opening 71 with, for example, press fit.

The bearing holding portion 72 is a concave portion in the mold resin 70 in which the second bearing 24 is held. A circuit board 5 is embedded in the portion on the −z-axis side of the mold resin 70 from the bearing holding portion 72. The circuit board 5 is connected to a power lead wire (not shown) for supplying power to the winding 20. The circuit board 5 is fixed to the insulator 60 with winding terminals 4, which are connected to the windings 20, in between. The fixing portion 73 is the portion of the electric motor 100 that is attached to the support of a mounting object (e.g., a motor support included in an outdoor unit). The fixing portion 73 extends outward in the radial direction from the end portion of the mold resin 70 on the anti-load side. The fixing portion 73 includes an insertion hole 73a in which a fastening member (e.g., a bolt) is inserted.

### Other Examples of Stator 1

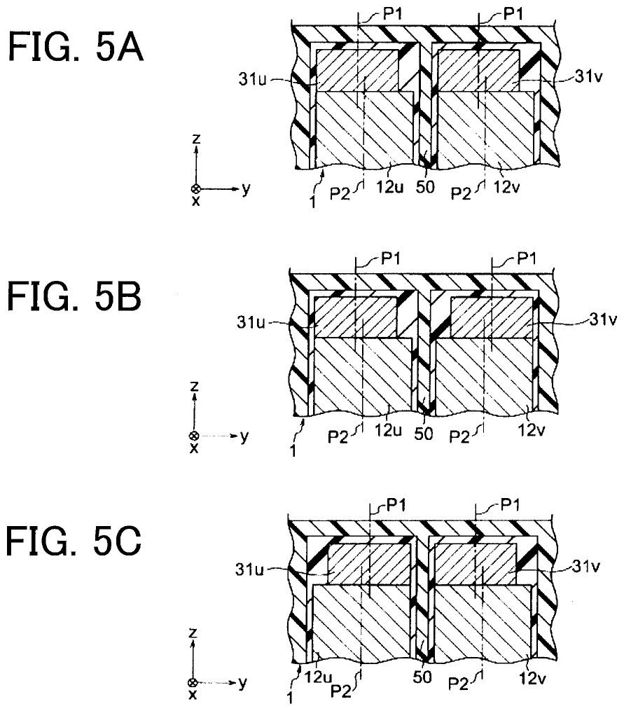

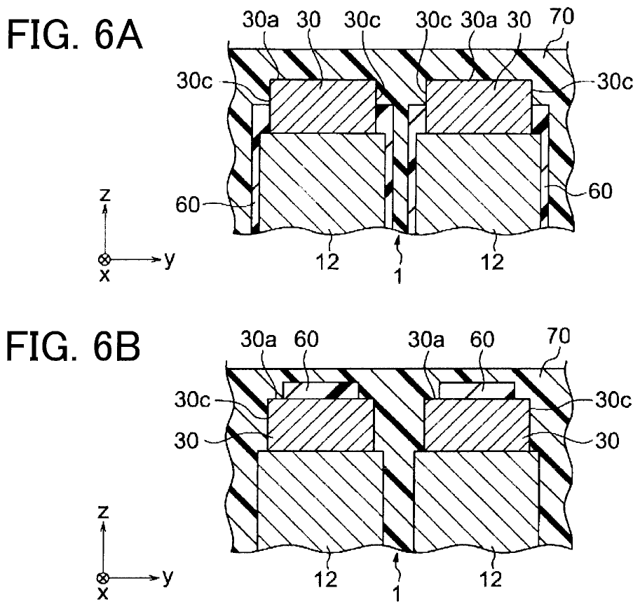

FIG. 5A to FIG. 5C are cross-sectional views showing other examples of the configuration of the stator 1 according to the first embodiment. In FIG. 5A, let be P1 the first center position that is the position of the center of each of the magnetic flux capture members 31u and 31v in the circumferential direction C, and let be P2 the second center position that is the position of each of the teeth 12u and 12v in the circumferential direction C. As shown in FIG. 5A to FIG. 5C, the first center position P1 may be shifted from the second center position P2 in the circumferential direction C (see FIG. 2). Accordingly, the torque fluctuation of the electric motor 100 is suppressed by skew effect, thereby further reducing noise.

FIG. 6A and FIG. 6B are cross-sectional views showing yet additional examples of the configuration of the stator 1 according to the first embodiment. As shown in FIG. 6A, the insulator 60 may cover a portion of a side surface 30c facing in the circumferential direction C (see FIG. 2) of the magnetic flux capture member 30, and the mold resin 70 may cover an end surface 30a facing in the +z axis direction of the magnetic flux capture member 30 and a portion of the side surface 30c. In other words, the insulator 60 can be achieved without covering the end surface 30a facing in the +z-axis direction of the magnetic flux capture member 30. Accordingly, the insulator 60 can be made smaller than the configuration shown in FIG. 3. Therefore, the amount of thermoplastic resin, which is more expensive than thermosetting resin, is reduced and consequently the cost of the electric motor 100 can be further reduced.

As shown in FIG. 6B, the insulator 60 covers a portion of the end surface 30a facing in the +z-axis direction of the magnetic flux capture member 30, and the mold resin 70 covers the end surface 30a and the side surface 30c facing in the circumferential direction C (see FIG. 2) of the magnetic flux capture member 30. In other words, the insulator 60 can be achieved without covering the side surface 30c facing in the circumferential direction C of the magnetic flux capture member 30. Accordingly, the amount of expensive thermoplastic resin is reduced compared to the configuration shown in FIG. 3 and consequently the cost of the electric motor 100 can be further reduced.

Next, additional examples of the shape of the insulator 60 of the resin 50 with reference to FIGS. 7A to 7E will be described. It should be noted that the illustration of the winding 20 is omitted in FIGS. 7A to 7E.

FIG. 7A is a cross-sectional view of another example of the configuration of the resin 50 shown in FIG. 4. As shown in FIG. 7A, the insulator 60 covers a portion of the surface 30b that faces outward in the radial direction of the magnetic flux capture member 30, and the mold resin 70 covers the end surface 30a that faces in the +z-axis direction of the magnetic flux capture member 30. In other words, the insulator 60 can be achieved without covering the end surface 30a facing in the +z-axis direction of the magnetic flux capture member 30.

FIGS. 7B to 7E are cross-sectional views showing yet additional examples of the configuration of the resin 50 shown in FIG. 4. In the example shown in FIG. 7B, the insulator 60 includes the first insulating portion 61 and the extending portion 63 that extends outward in the radial direction from the end on the stator core 10 side of the first insulating portion 61. In other words, the insulator 60 can be achieved without the second insulating portion 62 shown in FIG. 4.

Also, as shown in FIG. 7C, both the insulator 60 and the mold resin 70 may cover the end surface 30a of the magnetic flux capture member 30 that faces the +z-axis direction.

Also, as shown in FIG. 7D, the mold resin 70 may cover the surface 30b that faces outward in the radial direction of the magnetic flux capture member 30 and the end surface 30a that faces in the +z-axis direction. In the example shown in FIG. 7D, the insulator 60 is disposed away from the surface 30b, which faces outward in the radial direction of the magnetic flux capture member 30, with a space in between, and the space is filled with the mold resin 70. Accordingly, the insulator 60 can be made smaller.

Also, as shown in FIG. 7E, the magnetic flux capture member 30 may be mounted in a concave portion 61b provided in a surface 61a, which faces inward in the radial direction, of the first insulating portion 61 of the insulator 60. In other words, the magnetic flux capture member 30 may be disposed on the end surface, which faces in the +z-axis direction, of the stator core 10 with the resin 50 (in this case, insulator 60) in between.

### Winding 20

Next, the configuration of the winding 20 will be described with reference to FIG. 1. The winding 20 is wound around the tooth 12 of the stator core 10. The winding 20 is, for example, an aluminum wire, which is less expensive than a copper wire. Thus, the cost of the electric motor 100 can be reduced. As described above, in the electric motor 100, the axial length of the stator core 10 (i.e., length L1) is shorter than the axial length of the permanent magnet 22 (i.e., length L2). In this case, the circumference of the winding 20 is also shorter, and thus the resistance of the winding 20 is also smaller. Accordingly, even when an aluminum wire that has a lower conductivity than a copper wire is used for the winding 20, the increase in resistance is suppressed and the cost of the electric motor 100 can be reduced.

On the other hand, the tensile strength of an aluminum wire is lower than the tensile strength of a copper wire. For that reason, when the winding 20 is an aluminum wire, the tensile strength of the winding 20 during the winding process on the stator core 10 becomes low, and thus the fixing force of the winding 20 on the stator core 10 becomes small. In this case, the winding 20 is more likely to vibrate when a current is applied to the winding 20. In the first embodiment, the resin 50 (specifically, the mold resin 70) covers the winding 20. Accordingly, the vibration of the winding 20 can be suppressed even when a current is applied to the winding 20 made of an aluminum wire. Therefore, when the winding 20 is made of an aluminum wire and the winding 20 is covered by the mold resin 70, the cost of the stator 1 can be further reduced and the noise in the stator 1 can be further reduced. It should be noted that, in order to further reduce noise, the winding 20 may be an aluminum alloy wire having tensile strength greater than that of an aluminum wire.

### First Bearing 23 and Second Bearing 24

Next, the configurations of the first bearing 23 and the second bearing 24 will be described. If the first bearing 23 and the second bearing 24 are plain bearings, there is a gap between the plain bearing and the outer peripheral surface of the shaft 21. For that reason, during the rotation of the electric motor 100, the shaft 21 easily moves in the radial direction and thus the air gap between the permanent magnet 22 and the stator 1 easily changes. Therefore, if the first bearing 23 and the second bearing 24 are plain bearings, the size of the air gap between the permanent magnet 22 and the stator 1 easily becomes unbalanced in the axial direction during the rotation of the electric motor 100, and the vibration of the magnetic flux capture member 30 is easily generated.

The first bearing 23 and the second bearing 24 supporting the shaft 21 are rolling bearings. In this case, the first bearing 23 and the second bearing 24 each include an inner ring that is press-fitted onto the shaft 21, an outer ring that is fixed to the bearing holding portion, and rolling elements disposed between the inner ring and the outer ring. Accordingly, the shaft 21 is difficult to move in the radial direction during the rotation of the electric motor 100. For that reason, the air gap between the permanent magnet 22 and the stator 1 is difficult to change.

### Advantages of First Embodiment

According to the first embodiment described above, the length L1 in the z-axis direction of the stator core 10 is shorter than the length L2 in the z-axis direction of the permanent magnet 22. Accordingly, the number of electrical steel sheets used in the stator core 10 is reduced, and thus the cost of the stator 1 can be reduced. Therefore, the cost of the electric motor 100 can be reduced.

Also, according to the first embodiment, the stator 1 includes the magnetic flux capture member 30 made of magnetic material that captures the magnetic flux of the permanent magnet 22. Accordingly, the magnetic flux generated at the overhang portion of the permanent magnet 22 flows into the stator core 10 and the winding 20 through the magnetic flux capture member 30. Thus, the reduction in the amount of magnetic flux flowing from the permanent magnet 22 to the stator 1 can be suppressed. Therefore, the reduction in the output and efficiency of the electric motor 100 can be suppressed.

Also, according to the first embodiment, the first gap W1, which is the gap between adjacent magnetic flux capture members 30 in the circumferential direction C of the plurality of magnetic flux capture members 30, is filled with the resin 50. Accordingly, the magnetic flux capture members 30 are difficult to move in the circumferential direction C. Hence, even when the magnetic forces described above (e.g., the magnetic force of the permanent magnet 22 and the magnetic force generated when the winding 20 is energized) act on the magnetic flux capture member 30, the vibration of the magnetic flux capture member 30 can be suppressed. Thus, noise in the stator 1 can be reduced. Therefore, the cost of the electric motor 100 can be reduced, the reduction in the output and efficiency of the electric motor 100 can be suppressed, and the noise in the electric motor 100 can be also reduced.

Also, according to the first embodiment, the first gap W1 between the magnetic flux capture members 30 adjacent in the circumferential direction C is longer than the second gap W2 between the teeth 12 adjacent in the circumferential direction C. Accordingly, the magnetic force acting between the magnetic flux capture members 30 adjacent in the circumferential direction C can suppress the vibration of the magnetic flux capture members 30. Therefore, the noise in the stator 1 can be further reduced.

Also, according to the first embodiment, the thickness in the radial direction of the magnetic flux capture member 30 is thinner than the thickness in the radial direction of the tooth 12. Accordingly, the volume of the magnetic flux capture member 30 becomes smaller, and thus the amount of magnetic flux passing through the magnetic flux capture member 30 is reduced. Hence, the magnetic force acting on the magnetic flux capture member 30 is reduced, and thus the vibration of the magnetic flux capture member 30 can be suppressed. Therefore, the noise in the stator 1 can be further reduced.

Also, according to the first embodiment, the thickness in the radial direction of the resin 50 with which the first gap W1 is filled is thicker than the thickness in the radial direction of the magnetic flux capture member 30. Accordingly, the vibration of the magnetic flux capture member 30 is further suppressed, and the noise in the stator 1 can be further reduced.

Also, according to the first embodiment, the width in the circumferential direction C of the magnetic flux capture member 30 is narrower than the width in the circumferential direction C of the tooth 12. Accordingly, the surface area (in other words, volume) of the magnetic flux capture member 30 becomes smaller, and thus the amount of magnetic flux passing through the magnetic flux capture member 30 is reduced. Therefore, since the magnetic force in the magnetic flux capture member 30 is reduced, the vibration of the magnetic flux capture member 30 is further suppressed and the noise in the stator 1 can be further reduced.

Also, according to the first embodiment, the resin 50 covers the end surface 30a that faces in the +z-axis direction and the surface 30b that faces outward in the radial direction, of the magnetic flux capture member 30. Accordingly, the magnetic flux capture member 30 can be more firmly fixed to the tooth 12. Therefore, the vibration of the magnetic flux capture member 30 due to the magnetic force is suppressed, and the noise in the stator 1 can be further reduced.

Also, according to the first embodiment, in the rotor 2, the first bearing 23 and the second bearing 24 that support the shaft 21 are rolling bearings. Accordingly, the air gap between the rotor 2 and the stator 1 is less likely to change during the rotation of the electric motor 100 compared to a configuration in which the first bearing 23 and the second bearing 24 are plain bearings. Therefore, the vibration of the magnetic flux capture member 30 is further suppressed, and the noise in the stator 1 can be further reduced.

### First Modification of First Embodiment

FIG. 8 is a cross-sectional view showing a schematic configuration of an electric motor 100A according to a first modification of the first embodiment. In FIG. 8, each component identical or corresponding to a component shown in FIG. 1 is assigned the same reference sign as those in FIG. 1. The stator 1A of the electric motor 100A according to the first modification of the first embodiment differs from the stator 1 of the electric motor 100 according to the first embodiment in that the stator 1A does not have the magnetic flux capture member 32. Other than this, the electric motor 100A according to the first modification of the first embodiment is the same as the electric motor 100 according to the first embodiment. For that reason, the following description refers to FIG. 1 and FIG. 2.

As shown in FIG. 8, the electric motor 100A includes the stator 1A and the rotor 2.

The stator 1A includes the stator core 10, winding 20, a magnetic flux capture member 31A, and a resin 50A. In the first modification of the first embodiment, a magnetic flux capture member which is included in the stator 1A is only the magnetic flux capture member 31A. Accordingly, the number of components in the electric motor 100A is reduced, and the assembly process for the electric motor 100A can be simplified.

In the example shown in FIG. 8, the stator core 10 is disposed on the anti-load side (i.e., on the second bearing 24 side) from the center portion of permanent magnet 22 in the z-axis direction. Also, the length of the magnetic flux capture member 31A in the z-axis direction is longer than the length L of the stator core 10 in the z-axis direction (see FIG. 1). Accordingly, even when the stator 1 includes one magnetic flux capture member 31A, the magnetic flux of the permanent magnet 22 can easily flow into the stator core 10 and the winding 20 through the magnetic flux capture member 31A. Therefore, the decrease in the efficiency of the electric motor 100A can be prevented.

### Advantages of First Modification of First Embodiment

According to the first modification of the first embodiment described above, a magnetic flux capture member which is included in the stator 1A of the electric motor 100A is only the magnetic flux capture member 31A. Accordingly, the number of components constituting the electric motor 100A can be reduced, and the assembly process for the electric motor 100A can be simplified.

### Second Embodiment

FIG. 9 is a cross-sectional view schematically showing a part of the configuration of an electric motor 200 according to the second embodiment. In FIG. 9, each component identical or corresponding to a component shown in FIG. 1 is assigned the same reference sign as those in FIG. 1. The electric motor 200 according to the second embodiment differs from the electric motor 100 according to the first embodiment in terms of the configuration of a stator 201. Other than this, the electric motor 200 according to the second embodiment is the same as the electric motor 100 according to the first embodiment. For that reason, the following description refers to FIG. 2.

The electric motor 200 includes the stator 201 and the rotor 2.

The stator 201 includes the stator core 10, the winding 20, a magnetic flux capture member 230, and the resin 50.

The magnetic flux capture member 230 captures magnetic flux from the permanent magnet 22. The magnetic flux capture member 230 is disposed on the end surface of the tooth 12 in the axial direction (FIG. 2) of the stator core 10. The surface of the magnetic flux capture member 230 that faces the permanent magnet 22, that is, a surface 230d that faces inward in the radial direction, is located outward in the radial direction from an inner peripheral surface 10c of the stator core 10.

In FIG. 9, the gap between the outer peripheral surface 22a of the permanent magnet 22 and the inner peripheral surface 10c of the stator core 10 is a first air gap E1, and the gap between the outer peripheral surface 22a of the permanent magnet 22 and a surface 230d of the magnetic flux capture member 230 that faces inward in the radial direction is a second air gap E2. The second air gap E2 is larger than the first air gap E1. That is, the first air gap E1 and the second air gap E2 satisfy the following Expression (5).

$$E 1 > E 2 \qquad ( 5 )$$

Accordingly, the magnetic flux capture member 230 is less affected by the magnetic force of the permanent magnet 22, and thus the vibration of the magnetic flux capture member 230 due to the magnetic force can be suppressed. Therefore, the noise in the stator 201 can be reduced.

The resin 50 fixes the magnetic flux capture member 230 to the stator core 10. The mold resin 70 of the resin 50 is in contact with the surface 230d of the magnetic flux capture member 230 that faces inward in the radial direction. Accordingly, the area of the resin 50 that is in contact with the magnetic flux capture member 230 is increased compared to the configuration shown in FIG. 4, and thus the strength for fixing the magnetic flux capture member 230 to the stator core 10 is further increased. Therefore, the vibration of the magnetic flux capture member 230 can be further suppressed. It should be noted that the insulator 60 may be in contact with the surface 230d of the magnetic flux capture member 230 that faces inward in the radial direction.

In FIG. 9, let be t30 the thickness in the radial direction of the portion, which is located inward in the radial direction from the magnetic flux capture member 230, of the mold resin 70. The thickness t30 corresponds to the value obtained by subtracting the first air gap E1 from the second air gap E2. The thicker the thickness t30 becomes, the more difficult it becomes for the magnetic flux capturing member 230 to capture the magnetic flux of the permanent magnet 22, resulting in a decrease in the output and efficiency of the electric motor 200. For that reason, in the second embodiment, the thickness t30 is thinner than the thickness in the radial direction of the portion (e.g., insulator 60), which is located outward in the radial direction from the magnetic flux capture member 230, of the resin 50. Accordingly, the output and efficiency of the electric motor 200 can be prevented from decreasing. Therefore, the second embodiment can suppress the vibration of the magnetic flux capture member 230 and can prevent the reduction of the output and efficiency of the electric motor 200.

### Advantages of Second Embodiment

According to the second embodiment described above, the second air gap E2 between the outer peripheral surface 22a of the permanent magnet 22 and the surface 230d of the magnetic flux capture member 230 that faces inward in the radial direction is larger than the first air gap E1 between the outer peripheral surface 230a of the permanent magnet 22 and the inner peripheral surface 10c of the stator core 10. Accordingly, the magnetic flux capture member 230 is less affected by the magnetic force of the permanent magnet 22, and thus the vibration of the magnetic flux capture member 230 due to the magnetic force can be suppressed. Therefore, the noise in the stator 201, that is, the noise in the electric motor 200, can be reduced.

Also, according to the second embodiment, the thickness t30 of the mold resin 70, which is disposed on an inner side from the magnetic flux capture member 230 in the radial direction, of the resin 50 is thinner than the thickness of the part, which is located on an outer side from the magnetic flux capture member 230 in the radial direction, of the resin 50. Accordingly, the noise is reduced, and the decrease in the output and efficiency of the electric motor 200 can be prevented.

### Third Embodiment

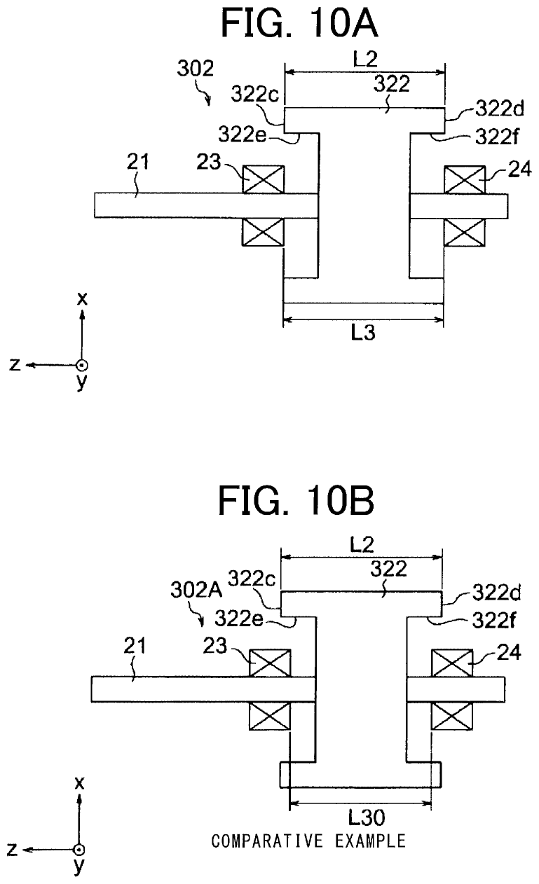

FIG. 10A is a partial cross-sectional view showing the configuration of a rotor 302 of an electric motor according to third embodiment. In FIG. 10A, each component identical or corresponding to a component shown in FIG. 1 is assigned the same reference sign as those in FIG. 1. The electric motor according to the third embodiment differs from the electric motor 100 according to the first embodiment in terms of the relationship between the distance between the first bearing 23 and the second bearing 24 and the length in the axial direction of the permanent magnet 322 in the rotor 302. In other respects, the electric motor 300 according to the third embodiment is the same as the electric motor 100 according to the first embodiment. For that reason, the following description refers to FIG. 1.

As shown in FIG. 10A, the rotor 302 includes the shaft 21, the permanent magnet 322, the first bearing 23, and the second bearing 24.

The permanent magnet 322 is attached to the shaft 21. The permanent magnet 322 includes a first depression 322e provided in an end surface 322c facing in the +z-axis direction and a second depression 322f in an end surface 322d facing in the −z-axis direction.

In FIG. 10A, a distance L3 is equal to a length L2, where L2 is the length of the permanent magnet 322 in the z-axis direction and L3 is the distance between the first bearing 23 and the second bearing 24. It should be noted that the distance L3 may be longer than the length L2. That is, the distance L3 and the length L2 only have to satisfy the following Expression (6).

$$L 3 \geq L 2 \qquad ( 6 )$$

The advantages in the case where the distance L3 and the length L2 satisfy the Expression (6) will be described in contrast to a comparative example. FIG. 10B is a partial cross-sectional view showing the configuration of the rotor 302A of an electric motor according to the comparative example. In the rotor 302A of the comparative example, a distance L30 between the first bearing 23 supporting the load side of the shaft 21 and the second bearing 24 supporting the anti-load side of the shaft 21 is shorter than the length L2. In this case, the force acting on the first bearing 23 located on the load side during the rotation of the electric motor is greater, and thus the first bearing 23 is more easily worn. The wear of the bearing is the wear of the inner and outer rings of the first bearing 23. When the wear occurs on the inner and outer rings, the gap between the inner ring and the outer ring increases. Accordingly, during the rotation, either the load portion or the anti-load portion of the shaft 21 is more likely to move in the radial direction. Therefore, a magnetic imbalance is generated between the magnetic flux flowing from the rotor 302A into the magnetic flux capture member 31 located on the +z-axis side (see, FIG. 1) and the magnetic flux flowing from the rotor 302A into the magnetic flux capture member 32 located on the −z-axis side (see, FIG. 1), and it is feared that vibration due to the magnetic imbalance is generated.

Also, for example, when the impeller 110 shown in FIG. 1 is attached to the load side of the shaft 21, the vibration and noise are generated due to the bending the shaft 21 during its rotation. If the vibration component based on the bending of the shaft 21 resonates with the vibration component based on the magnetic imbalance described above, it is feared that even louder noise will be generated.

In the third embodiment, as described above in Equation (6), the distance L3 between the first bearing 23 located on the load side and the second bearing 24 located on the anti-load side is greater than or equal to the length L2 of the permanent magnet 322 in the axial direction. Accordingly, the force acting on the first bearing 23 and the second bearing 24 during the rotation of the electric motor according to the third embodiment is reduced. Hence, the wear of the first bearing 23 and the second bearing 24 is suppressed, thereby making it difficult for the shaft 21 to move in the radial direction during the rotation of the electric motor. Therefore, the magnetic imbalance between the magnetic flux flowing from the rotor 302 into the magnetic flux capture member 31 located on the +z-axis side (see, FIG. 1) and the magnetic flux flowing from the rotor 302 into the magnetic flux capture member 32 located on the −z-axis side (see, FIG. 1) can be reduced, and the vibration due to the magnetic imbalance can be further suppressed.

### Advantages of Third Embodiment

According to the third embodiment described above, the distance L3 between the first bearing 23 located on the load side of the shaft 21 and the second bearing 24 located on the anti-load side of the shaft 21 is longer than the length L2 of the permanent magnet 322 in the axial direction. Accordingly, the noise in the electric motor according to the third embodiment can be further reduced.

### Fourth Embodiment

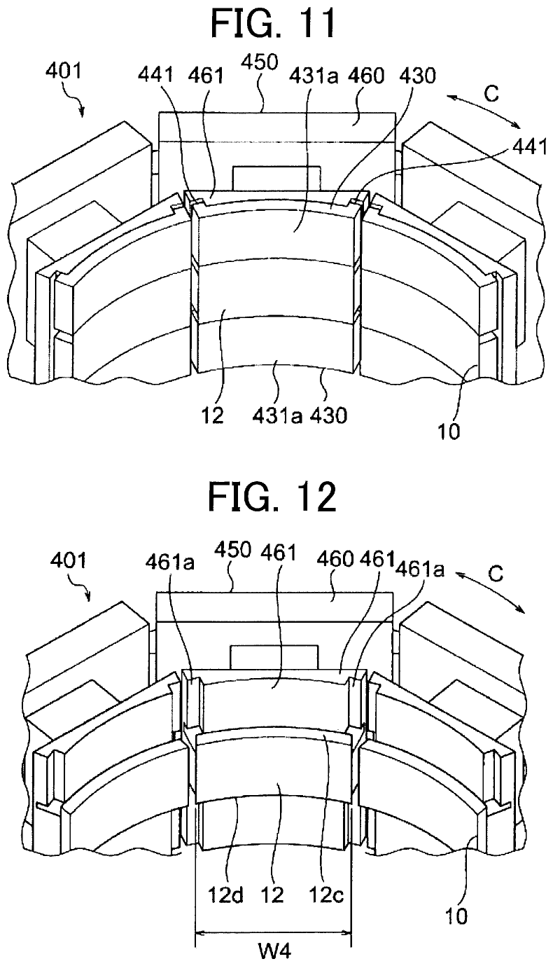

FIG. 11 is a perspective view showing the configuration of the stator 401 of the electric motor according to fourth embodiment. FIG. 12 is a perspective view showing the stator core 10 and an insulator 460 shown in FIG. 11. In FIGS. 11 and 12, each component identical or corresponding to a component shown in FIG. 1 is assigned the same reference sign as those in FIG. 1. The electric motor according to the fourth embodiment differs from the electric motor 100 according to the first embodiment in terms of the shape of a magnetic flux capture member 430 of the stator 401. Other than this, the electric motor according to the fourth embodiment is the same as the electric motor 100 according to the first embodiment. For that reason, the following description refers to FIG. 1.

The stator 401 includes the stator core 10, the winding 20 (see, FIG. 1), the magnetic flux capture member 430, and a resin 450.

The magnetic flux capture member 430 captures magnetic flux which flows from the rotor 2. The magnetic flux capture members 430 are disposed on the end surfaces 12c and 12d, respectively, in the z-axis direction of the tooth 12 of the stator core 10.

The magnetic flux capture member 430 includes a concave surface 431a facing inward in the radial direction. The shape of the magnetic flux capture member 430 when viewed in the z-axis direction is, for example, a circular arc shape. Accordingly, the contact area between the stator core 10 and the magnetic flux capture member 430 is increased compared to a configuration in which the shape of the magnetic flux capture member when viewed in the z-axis direction is rectangular, and thus the strength for fixing the magnetic flux capture member 430 can be improved.

The resin 450 includes an insulator 460 that insulates the stator core 10 from the winding, and a mold resin not shown.

The insulator 460 includes a first insulating portion 461 that insulates the tooth 12 from the winding 20. The magnetic flux capture member 430 is in contact with the first insulating portion 461 of the insulator 460. Accordingly, the positioning of the magnetic flux capture member 430 is facilitated.

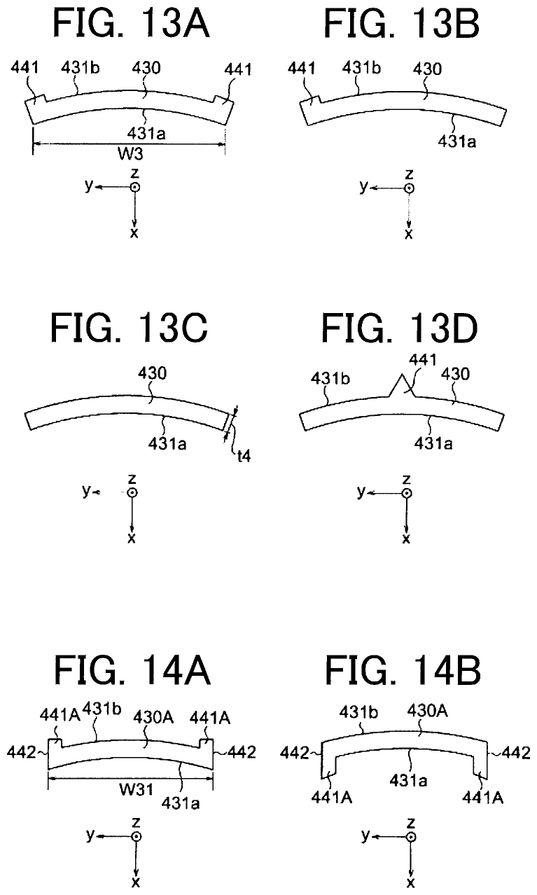

FIG. 13A is a plan view showing the magnetic flux capture member 430 shown in FIG. 11. As shown in FIG. 13A, the magnetic flux capture member 430 includes a plurality of protruding portions 441 provided on a surface 431b that faces outward in the radial direction.

In the example shown in FIG. 13A, the protruding portions 441 project in a direction (i.e., outward in the radial direction) away from the permanent magnet 22 (see, FIG. 1) from the ends of both sides in the circumferential direction C of the surface 431b facing outward in the radial direction. Also, in the example shown in FIG. 13A, the protruding portions 441 protrude outward in the radial direction so that the magnetic flux capture member 430 is wider in the circumferential direction C. Accordingly, even if a magnetic attractive force is generated between the permanent magnet 22 and the magnetic flux capture member 430 during rotation, the magnetic flux capture member 430 is difficult to dropout. Therefore, the reliability of the electric motor can be improved.

In FIG. 13A, a width W3 is narrower than a width W4, where W3 is the width in the circumferential direction C of the magnetic flux capture member 430 and W4 is the width in the circumferential direction C of the tooth end portion 12b in FIG. 12 described above. That is, the width W3 and the width W4 satisfy the following Expression (7).

$$W 3 < W 4 \qquad ( 7 )$$

Accordingly, interference between two magnetic flux capture members 430 adjacent to each other in the circumferential direction C can be prevented.

Also, as shown in FIG. 11 and FIG. 12, the protruding portions 441 are fitted into recesses 461a provided in the surface of the insulator 460 facing inward in the radial direction. Accordingly, the strength of fixing the magnetic flux capture member 430 is improved. Therefore, even when magnetic forces (e.g., the magnetic force of the permanent magnet 22 and the magnetic force generated when the winding 20 is energized) act on the magnetic flux capture member 430, the vibration of the magnetic flux capture member 430 can be suppressed. Therefore, the noise in the stator can be reduced.

FIG. 13B to FIG. 13D are plan views showing other examples of the configuration of the magnetic flux capture member 430 according to the fourth embodiment. The protruding portion 441 can be achieved without protruding outward in the radial direction from both ends in the circumferential direction C of the magnetic flux capture member 430. For example, as shown in FIG. 13B, the protruding portion 441 may protrude outward in the radial direction from one end in the circumferential direction C of the surface 431b facing outward in the radial direction. Also, as shown in FIG. 13C, the magnetic flux capture member 430 may be achieved without the protruding portion 441, and the thickness t4 in the radial direction of the magnetic flux capture member 430 may be uniform in the circumferential direction C. Accordingly, the size of the magnetic flux capture member 430 required to capture the magnetic flux of the permanent magnet 22 (see, FIG. 1) can be minimized. In addition, as shown in FIG. 13D, the protruding portion 441 may be provided at the center portion in the circumferential direction C of the surface 431b, which faces outward in the radial direction, of the magnetic flux capture member 430. Accordingly, interference between the protruding portion 441 and other adjacent magnetic flux capture member 430 in the circumferential direction C can be prevented.

### Advantages of Fourth Embodiment

According to the fourth embodiment described above, the magnetic flux capture member 430 includes the concave surface 431a facing inward in the radial direction. The shape of the magnetic flux capture member 430 when viewed in the z-axis direction is, for example, a circular arc shape. Accordingly, the contact area between the stator core 10 and the magnetic flux capture member 430 is increased compared to a configuration in which the shape of the magnetic flux capture member when viewed in the z-axis direction is rectangular, and thus the strength for fixing the magnetic flux capture member 430 can be improved.

Also, according to the fourth embodiment, the magnetic flux capture member 430 includes the protruding portion 441 provided on the surface 431b facing outward in the radial direction. Accordingly, the contact area between the stator core 10 and the magnetic flux capture member 430 is further increased, and thus the strength for fixing the magnetic flux capture member 430 can be further improved. Also, the positioning of the magnetic flux capture member 430 in fixing the magnetic flux capture member 430 to the insulator 460 can be facilitated.

Also, according to the fourth embodiment, the protruding portion 441 protrudes outward in the radial direction from the surface 431b, which faces outward in the radial direction, of the magnetic flux capture member 430, and the protruding portion 441 is fitted into the recess 461a provided in the surface, which faces inward in the radial direction, of the insulator 460. Accordingly, the strength for fixing the magnetic flux capture member 430 is improved. Hence, even when magnetic forces (e.g., the magnetic force of the permanent magnet 22 and the magnetic force generated when the winding 20 is energized) act on the magnetic flux capture member 430, the vibration of the magnetic flux capture member 430 can be suppressed. Therefore, the noise in the stator can be reduced.

### First Modification of Fourth Embodiment

FIG. 14A is a plan view showing a configuration of a magnetic flux capture member 430A of a stator according to first modification of the fourth embodiment. In FIG. 14A, each component identical or corresponding to a component shown in FIG. 13A is assigned the same reference sign as those in FIG. 13A. The stator according to the first modification of the fourth embodiment differs from the stator 401 according to the fourth embodiment in terms of the shape of the magnetic flux capture member 430A. Other than this, the stator according to the first modification of the fourth embodiment is the same as the stator according to the fourth embodiment. For that reason, the following description refers to FIG. 11, or the like.

As shown in FIG. 14A, the magnetic flux capture member 430A includes a plurality of protruding portions 441A provided at the ends of both sides in the circumferential direction C of the surface 431b facing outward in the radial direction.

The protruding portions 441A protrude from the ends in the circumferential direction C of the surface 431b facing outward in the radial direction so that the width W31 in the circumferential direction C of the magnetic flux capture member 430A is uniform. Accordingly, when the magnetic flux capture members 430A are disposed on the teeth 12 (see, FIG. 11) respectively, the interference of two magnetic flux capture members 430A adjacent to each other in the circumferential direction C can be prevented. Hence, in the first modification of the fourth embodiment, the width W31 in the circumferential direction C of the magnetic flux capture member 430 can be widened to the width W4 in the circumferential direction C of the tooth end portion 12b of the tooth 12. Therefore, the magnetic flux capture member 430A can easily capture the magnetic flux generated at the overhang portion of the permanent magnet 22 (see, FIG. 1). It should be noted that, in FIG. 14A, the width W31 in the circumferential direction C of the magnetic flux capture member 430A is the shortest distance between the side surfaces 442 on both sides in the circumferential direction C of the magnetic flux capture member 430A.

FIG. 14B is a plan view showing other example of the configuration of the magnetic flux capture member 430A of the stator according to the first modification of the fourth embodiment. As shown in FIG. 14B, the protruding portions 441A of the magnetic flux capture member 430A may protrude from the concave surface 431a facing inward in the radial direction toward the permanent magnet 22 (see FIG. 1). That is, the protruding portions 441A of the magnetic flux capture member 430A may protrude inward in the radial direction. In the example shown in FIG. 14B, an insulator, mold resin, or the like covers the concave surface 431a, thereby preventing the magnetic flux capture member 430A from dropping off due to magnetic force generated between the rotor 2 (see, FIG. 1) and the stator 401 (see, FIG. 11).

### Advantages of First Modification of Fourth Embodiment

According to the first modification of the fourth embodiment described above, the protruding portion 441A protrudes from the surface 431b facing outward in the radial direction or the concave surface 431a facing inward in the radial direction so that the width W31 in the circumferential direction C of the magnetic flux capture member 430A is uniform. Accordingly, the interference between two magnetic flux capture members 430A adjacent to each other in the circumferential direction C can be prevented. Hence, the width W3 in the circumferential direction C of the magnetic flux capture member 430A can be widened to the width W2 in the circumferential direction C of the tooth end portion 12b of the tooth 12. Therefore, the magnetic flux capture member 430A can easily capture the magnetic flux generated at the overhang portion of the permanent magnet 22.

### Second Modification of Fourth Embodiment

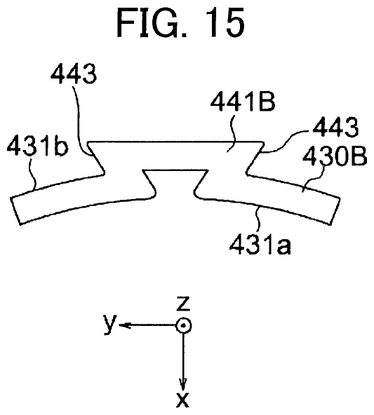

FIG. 15 is a plan view showing a configuration of a magnetic flux capture member 430B of a stator according to the second modification of the fourth embodiment. In FIG. 15, each component identical or corresponding to a component shown in FIG. 13A is assigned the same reference sign as those in FIG. 13A. The stator according to the second modification of the fourth embodiment differs from the stator according to the fourth embodiment in terms of the shape of the magnetic flux capture member 430B. Other than this, the stator according to the second modification of the fourth embodiment is the same as the stator according to the fourth embodiment. For that reason, the following description refers to FIG. 11, or the like.

As shown in FIG. 15, the magnetic flux capture member 430B includes a protruding portion 441B provided on the surface 431b facing outward in the radial direction. The protruding portions 441B protrude outward in the radial direction from the center portion in the circumferential direction C of the surface 431b facing outward in the radial direction. Accordingly, when the magnetic flux capture members 430B are disposed on the teeth 12 respectively (see, FIG. 11), two magnetic flux capture members 430B adjacent to each other in the circumferential direction C can be prevented from interfering with each other.

Also, in the second modification of the fourth embodiment, the protruding portion 441B is wider as it away from the surface 431b facing outward in the radial direction. Specifically, side surfaces 443 facing in the circumferential direction C of the protruding portion 441B extend and tilt in the circumferential direction C so that the protruding portion 441B becomes wider as it away from the surface 431b facing outward in the radial direction. When an insulator or a mold resin covers the side surfaces 443, the strength for fixing the magnetic flux capture member 430B is improved, thereby preventing the magnetic flux capture member 430B from dropping off due to the magnetic force generated between the rotor 2 (see, FIG. 1) and the stator 401 (see, FIG. 11).

### Advantages of Second Modification of Fourth Embodiment

According to the second modification of the fourth embodiment described above, the protruding portion 441B of the magnetic flux capture member 430B is wider as it away from the surface 431b facing outward in the radial direction. Accordingly, the strength for fixing the magnetic flux capture member 430B to the resin is improved, and thus the magnetic flux capture member 430B can be prevented from dropping off due to the magnetic force generated between the rotor 2 and the stator 401.

1. An electric motor comprising:
a stator; and
a rotor body disposed inside the stator;
a rotation shaft attached to the rotor body;
a first bearing that supports a load side of the rotation shaft; and
a second bearing that supports an anti-load side of the rotation shaft,
wherein the stator includes:
a stator core including a plurality of teeth;
a plurality of magnetic flux capture members; and
a resin to fix the magnetic flux capture members to end surfaces, in an axial direction of the stator core, of the teeth respectively,
wherein the magnetic flux capture members, which are adjacent in a circumferential direction of the stator core, of the plurality of magnetic flux capture members are disposed in the circumferential direction with a first gap in between,
the first gap is filled with the resin, and
a distance between the first bearing and the second bearing in the axial direction is greater than or equal to a length of the rotor body in the axial direction.

2. The electric motor according to claim 1, wherein the first gap is greater than or equal to a second gap that is a gap between the teeth, which is adjacent in the circumferential direction, of the plurality of teeth.

3. The electric motor according to claim 1, wherein a width in the circumferential direction of each of the magnetic flux capture members of the plurality of magnetic flux capture members is narrower than a width in the circumferential direction of each of the teeth of the plurality of teeth.

4. The electric motor according to claim 1, wherein a first center position that is a position of a center of the magnetic flux capture member in the circumferential direction is shifted from a second center position that is a position of a center of the tooth in the circumferential direction.

5. The electric motor according to claim 1, wherein a first thickness that is a thickness, in a radial direction of the stator core, of the magnetic flux capture member is thinner than a second thickness that is a thickness of the tooth in the radial direction.

6. The electric motor according to claim 5, wherein a third thickness that is a thickness of the resin in the radial direction is thicker than the first thickness.

7. The electric motor according to claim 1, wherein the resin surrounds the plurality of magnetic flux capture members so as to fix the magnetic flux capture members to end surfaces in the axial direction of the plurality of teeth.

8. The electric motor according to claim 1, wherein the magnetic flux capture members are disposed on end surfaces in the axial direction of the teeth with the resin in between.

9. The electric motor according to claim 1, wherein the magnetic flux capture member includes a protruding portion provided on a surface that faces outward or inward in a radial direction of the stator core.

10. The electric motor according to claim 9, wherein
the protruding portion protrudes outward in the radial direction from the surface, which faces outward in the radial direction, of the magnetic flux capture member,
the resin includes a recess provided in a surface that faces inward in the radial direction, and
the protruding portion is fitted into the recess.

11. The electric motor according to claim 1, wherein the stator includes a winding wound around the stator core,
wherein the resin includes
an insulator that insulates the winding from the stator core, and
a mold resin that covers the winding.

12. The electric motor according to claim 11, wherein the winding is an aluminum wire.

13. (canceled)

14. The electric motor according to claim 13, wherein a first length that is a length of the stator core in the axial direction is shorter than a second length that is a length of the rotor body in the axial direction.

15. (canceled)

16. The electric motor according to claim 1, wherein a first air gap that is a gap between the rotor body and the magnetic flux capture member is wider than a second air gap that is a gap between the rotor body and the stator core.

17. The electric motor according to claim 16, wherein the resin covers a surface, which faces the rotor body, of the magnetic flux capture member.

18. A blower comprising:
the electric motor according to claim 1; and
an impeller driven by the electric motor.

19. The blower according to claim 18, wherein an outer diameter of the impeller is larger than an outer diameter of the stator core.
